(19) United States
(12) Patent Application Publication
(10) Pub. No.: US 2018/0176373 A1
(43) Pub. Date: Jun. 21, 2018

(54) CALL FORWARDING METHOD AND DEVICE, AND TERMINAL

(71) Applicant: SPREADTRUM COMMUNICATIONS (SHANGHAI) CO., LTD., Shanghai (CN)

(72) Inventors: Jinjin NI, Zhangjiang (CN); Xichun GAO, Zhangjiang (CN); Xianliang CHEN, Zhangjiang (CN); Yi HE, Zhangjiang (CN); Qiang WANG, Zhangjiang (CN)

(21) Appl. No.: 15/802,990

(22) Filed: Nov. 3, 2017

(30) Foreign Application Priority Data
Dec. 16, 2016 (CN) 201611168728.0

(51) Int. Cl. H04M 3/436; H04M 3/54; H04M 3/428

(52) U.S. Cl. CPC H04M 3/4365; H04M 7/0057; H04M 3/428; H04M 3/541

(57) ABSTRACT

Call forwarding method and device, and a terminal are provided. The method includes: receiving an incoming call request from a remote subscriber; determining whether the remote subscriber is a contact in an address book for whom a target forwarding subscriber has been predetermined and whether the incoming call request of the remote subscriber meets a condition of triggering forwarding; and if the remote subscriber is the contact in the address book for whom the target forwarding subscriber has been predetermined, and the incoming call request of the remote subscriber meets the condition of triggering forwarding, forwarding the incoming call request of the remote subscriber to the target forwarding subscriber. A target forwarding subscriber and a condition of triggering forwarding may be predetermined flexibly, and the call forwarding may be performed more flexibly.

### CROSS-REFERENCE TO RELATED APPLICATIONS

This present application claims the benefit of priority under 35 U.S.C. § 119 to Chinese patent application No. 201611168728.0, filed on Dec. 16, 2016 and the entire disclosure of which is incorporated herein by reference.

### TECHNICAL FIELD

The present disclosure generally relates to communication field, and more particularly, to call forwarding method and device, and a terminal.

### BACKGROUND

With the development of communication technology, functions of a communication terminal are increasing, and users' demands on call service become more diverse. For example, a terminal supporting single subscriber and multi-pass functions can realize video call, call forwarding and multi-party call among multiple subscribers.

In existing call forwarding solutions, several conditions of triggering forwarding and target forwarding subscribers are predetermined at a network, and when there is a call meeting the condition, the call is forwarded to the target forwarding subscriber.

Inventors found that the existing techniques have following questions. The call forwarding relies on the network, and call forwarding only occurs in a few fixed scenes, such as busy to forward or no response to forward, which is inflexible. Besides, the conditions of triggering forwarding are the same for all incoming calls, and the corresponding target forwarding subscribers are also fixed, which cannot be flexibly changed.

### SUMMARY

In embodiments of the present disclosure, call forwarding method and device, and a terminal are provided, which may flexibly predetermine a target forwarding subscriber and a condition of triggering forwarding, and improve flexibility of call forwarding.

In an embodiment of the present disclosure, a call forwarding method is provided, including: receiving an incoming call request from a remote subscriber; determining whether the remote subscriber is a contact in an address book for whom a target forwarding subscriber has been predetermined and whether the incoming call request of the remote subscriber meets a condition of triggering forwarding; and if the remote subscriber is the contact in the address book for whom the target forwarding subscriber has been predetermined, and the incoming call request of the remote subscriber meets the condition of triggering forwarding, forwarding the incoming call request of the remote subscriber to the target forwarding subscriber.

Optionally, determining whether the incoming call request of the remote subscriber meets a condition of triggering forwarding may include: determining whether there is no response to the incoming call request of the remote subscriber within a predetermined time period; and if the remote subscriber is the contact in the address book for whom the target forwarding subscriber has been predetermined, and the incoming call request of the remote subscriber meets the condition of triggering forwarding, forwarding the incoming call request of the remote subscriber to the target forwarding subscriber may include: if the remote subscriber is the contact in the address book for whom the target forwarding subscriber has been predetermined, and there is no response to the incoming call request of the remote subscriber within the predetermined time period, forwarding the incoming call request of the remote subscriber to the target forwarding subscriber.

Optionally, determining whether the incoming call request of the remote subscriber meets a condition of triggering forwarding may include: determining whether call forwarding indication for the incoming call request of the remote subscriber is received; and if the remote subscriber is the contact in the address book for whom the target forwarding subscriber has been predetermined, and the incoming call request of the remote subscriber meets the condition of triggering forwarding, forwarding the incoming call request of the remote subscriber to the target forwarding subscriber may include: if the remote subscriber is the contact in the address book for whom the target forwarding subscriber has been predetermined, and call forwarding indication for the incoming call request of the remote subscriber is received, forwarding the incoming call request of the remote subscriber to the target forwarding subscriber.

Optionally, determining whether the incoming call request of the remote subscriber meets a condition of triggering forwarding may include: determining whether the incoming call request of the remote subscriber is received; and if the remote subscriber is the contact in the address book for whom the target forwarding subscriber has been predetermined, and the incoming call request of the remote subscriber meets the condition of triggering forwarding, forwarding the incoming call request of the remote subscriber to the target forwarding subscriber may include: if the remote subscriber is the contact in the address book for whom the target forwarding subscriber has been predetermined, forwarding the incoming call request of the remote subscriber to the target forwarding subscriber.

In an embodiment of the present disclosure, a call forwarding device is provided, including: a receiving circuitry configured to receive an incoming call request from a remote subscriber; a determining circuitry configured to determine whether the remote subscriber is a contact in an address book for whom a target forwarding subscriber has been predetermined and whether the incoming call request of the remote subscriber meets a condition of triggering forwarding; and a forwarding circuitry configured to: if the remote subscriber is the contact in the address book for whom the target forwarding subscriber has been predetermined, and the incoming call request of the remote subscriber meets the condition of triggering forwarding, forward the incoming call request of the remote subscriber to the target forwarding subscriber.

Optionally, the determining circuitry may be configured to determine whether there is no response to the incoming call request of the remote subscriber within a predetermined time period; and the forwarding circuitry may be configured to: if the remote subscriber is the contact in the address book for whom the target forwarding subscriber has been predetermined, and there is no response to the incoming call request of the remote subscriber within the predetermined time period, forward the incoming call request of the remote subscriber to the target forwarding subscriber.

Optionally, the determining circuitry may be configured to determine whether call forwarding indication for the incoming call request of the remote subscriber is received; and the forwarding circuitry may be configured to: if the remote subscriber is the contact in the address book for whom the target forwarding subscriber has been predetermined, and call forwarding indication for the incoming call request of the remote subscriber is received, forward the incoming call request of the remote subscriber to the target forwarding subscriber.

Optionally, the determining circuitry may be configured to determine whether the incoming call request of the remote subscriber is received; and the forwarding circuitry may be configured to: if the remote subscriber is the contact in the address book for whom the target forwarding subscriber has been predetermined, forward the incoming call request of the remote subscriber to the target forwarding subscriber.

In an embodiment of the present disclosure, a mobile terminal including the above call forwarding device is provided.

In the call forwarding method and device, and the terminal provided by embodiments of the present disclosure, whether a remote subscriber which initiates an incoming call request is a contact in an address book for whom a target forwarding subscriber has been predetermined and whether the incoming call request of the remote subscriber meets a condition of triggering forwarding are determined, to realize the call forwarding in different scenes. Compared with the existing techniques, embodiments of the present disclosure may predetermine a target forwarding subscriber and a condition of triggering forwarding more flexibly, and improve flexibility of call forwarding.

### BRIEF DESCRIPTION OF THE DRAWINGS

FIG. 1 schematically illustrates a flow chart of a call forwarding method according to an embodiment;

FIG. 2 schematically illustrates a diagram of a detailed example of a call forwarding method according to an embodiment; and

FIG. 3 schematically illustrates a structural diagram of a call forwarding device according to an embodiment.

### DETAILED DESCRIPTION

In order to clarify the object, solutions and advantages of embodiments of the present disclosure, embodiments of present disclosure will be described clearly in detail in conjunction with accompanying drawings. The embodiments below are only described for example, and there are many other possible embodiments. Based on the embodiments below, all the other embodiments obtained by those skilled in the art without any creative efforts should belong to the scope of the present disclosure.

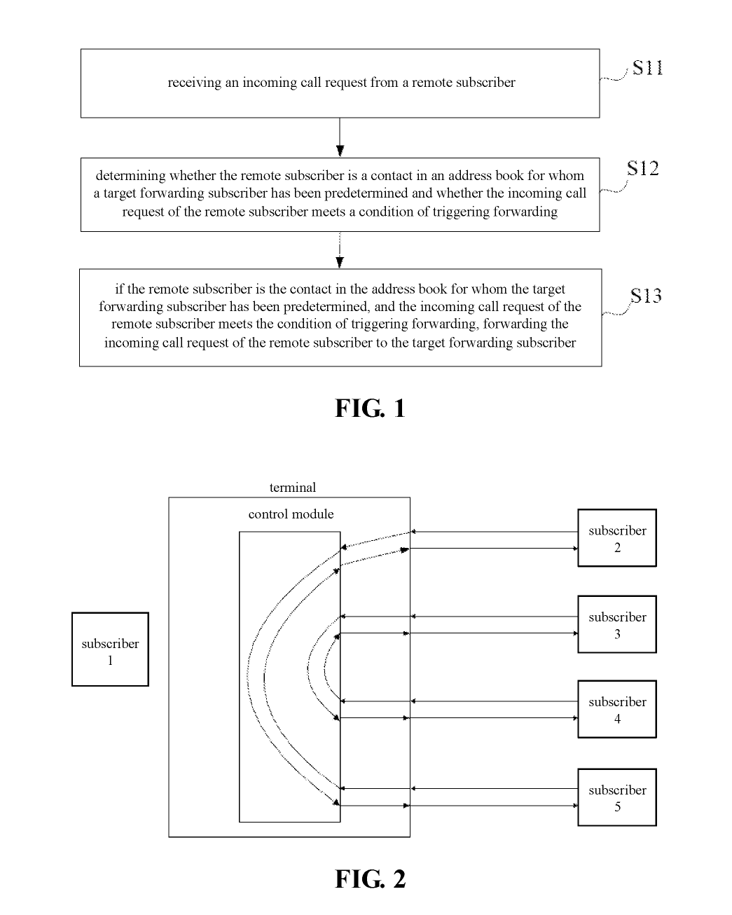

FIG. 1 schematically illustrates a flow chart of a call forwarding method according to an embodiment. Referring to FIG. 1, the method may include:

S11, receiving an incoming call request from a remote subscriber;

S12, determining whether the remote subscriber is a contact in an address book for whom a target forwarding subscriber has been predetermined and whether the incoming call request of the remote subscriber meets a condition of triggering forwarding; and

S13, if the remote subscriber is the contact in the address book for whom the target forwarding subscriber has been predetermined, and the incoming call request of the remote subscriber meets the condition of triggering forwarding, forwarding the incoming call request of the remote subscriber to the target forwarding subscriber.

In some embodiments, after the incoming call request is received from the remote subscriber, whether a target forwarding subscriber has been predetermined for the remote subscriber is determined. If it is determined that a target forwarding subscriber has been predetermined for the remote subscriber, whether the incoming call request meets the condition of triggering forwarding is further determined. If it is determined that the incoming call request meets the condition of triggering forwarding, the incoming call request of the remote subscriber is forwarded to the target forwarding subscriber.

In some embodiments, after the incoming call request is received from the remote subscriber, whether the incoming call request meets the condition of triggering forwarding is determined. If it is determined that the incoming call request meets the condition of triggering forwarding, whether a target forwarding subscriber has been predetermined for the remote subscriber is determined. If it is determined that a target forwarding subscriber has been predetermined for the remote subscriber, the incoming call request of the remote subscriber is forwarded to the target forwarding subscriber.

In some embodiments, the condition of triggering forwarding may include there being no response to the incoming call request in a predetermined time period, interface selection or receiving an incoming call.

In some embodiments, if the condition of triggering forwarding is there being no response to the incoming call request in a predetermined time period, whether there is no response to the incoming call request of the remote subscriber within a predetermined time period is determined. If the remote subscriber is the contact in the address book for whom the target forwarding subscriber has been predetermined, and there is no response to the incoming call request of the remote subscriber within the predetermined time period, the incoming call request of the remote subscriber is forwarded to the target forwarding subscriber.

In some embodiments, if the condition of triggering forwarding is interface selection, whether call forwarding indication for the incoming call request of the remote subscriber is received is determined. If the remote subscriber is the contact in the address book for whom the target forwarding subscriber has been predetermined, and call forwarding indication for the incoming call request of the remote subscriber is received, the incoming call request of the remote subscriber is forwarded to the target forwarding subscriber.

In some embodiments, the condition of triggering forwarding is receiving an incoming call. If the remote subscriber is the contact in the address book for whom the target forwarding subscriber has been predetermined, the incoming call request of the remote subscriber is directly forwarded to the target forwarding subscriber.

Detailed description is made in conjunction with a specific example. Referring to FIG. 2, for an incoming call from a subscriber 2, a subscriber 5 is predetermined as a target forwarding subscriber, and a condition of triggering forwarding is that there is no response within ten seconds. For an incoming call from a subscriber 3, a subscriber 4 is predetermined as a target forwarding subscriber, and a condition of triggering forwarding is receiving an incoming call. If a subscriber 1 doesn't make any response within ten seconds after receiving the incoming call from the subscriber 2, the incoming call of the subscriber 2 may be forwarded to the subscriber 5. When receiving the incoming call from the subscriber 3, the subscriber 1 may directly forward the incoming call of the subscriber 3 may be forwarded to the subscriber 4. Optionally, for an incoming call from the subscriber 3, the subscriber 4 is predetermined as a target forwarding subscriber, and a condition of triggering forwarding is interface selection. When receiving the incoming call from the subscriber 3, a terminal of the subscriber 1 may present an interface which reminds the subscriber 1 to select whether to perform call forwarding. If the subscriber 1 selects in the interface to perform call forwarding, the incoming call of the subscriber 3 is forwarded to the subscriber 4.

In the call forwarding method provided by embodiments of the present disclosure, whether a remote subscriber which initiates an incoming call request is a contact in an address book for whom a target forwarding subscriber has been predetermined and whether the incoming call request of the remote subscriber meets a condition of triggering forwarding are determined, to realize the call forwarding in different scenes. Compared with the existing techniques, embodiments of the present disclosure may predetermine a target forwarding subscriber and a condition of triggering forwarding more flexibly, and improve flexibility of call forwarding.

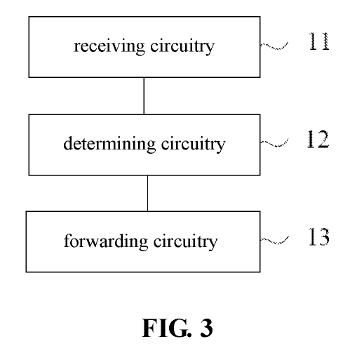

Referring to FIG. 3, in an embodiment of the present disclosure, a call forwarding device for a multi-channel terminal is provided, including: a receiving circuitry 11 configured to receive an incoming call request from a remote subscriber; a determining circuitry 12 configured to determine whether the remote subscriber is a contact in an address book for whom a target forwarding subscriber has been predetermined and whether the incoming call request of the remote subscriber meets a condition of triggering forwarding; and a forwarding circuitry 13 configured to: if the remote subscriber is the contact in the address book for whom the target forwarding subscriber has been predetermined, and the incoming call request of the remote subscriber meets the condition of triggering forwarding, forward the incoming call request of the remote subscriber to the target forwarding subscriber.

In some embodiments, the determining circuitry 12 may be configured to determine whether there is no response to the incoming call request of the remote subscriber within a predetermined time period; and the forwarding circuitry 13 may be configured to: if the remote subscriber is the contact in the address book for whom the target forwarding subscriber has been predetermined, and there is no response to the incoming call request of the remote subscriber within the predetermined time period, forward the incoming call request of the remote subscriber to the target forwarding subscriber.

In some embodiments, the determining circuitry 12 may be configured to determine whether call forwarding indication for the incoming call request of the remote subscriber is received; and the forwarding circuitry 13 may be configured to: if the remote subscriber is the contact in the address book for whom the target forwarding subscriber has been predetermined, and call forwarding indication for the incoming call request of the remote subscriber is received, forward the incoming call request of the remote subscriber to the target forwarding subscriber.

In some embodiments, the determining circuitry 12 may be configured to determine whether the incoming call request of the remote subscriber is received; and the forwarding circuitry 13 may be configured to: if the remote subscriber is the contact in the address book for whom the target forwarding subscriber has been predetermined, forward the incoming call request of the remote subscriber to the target forwarding subscriber.

In the call forwarding device provided by embodiments of the present disclosure, whether a remote subscriber which initiates an incoming call request is a contact in an address book for whom a target forwarding subscriber has been predetermined and whether the incoming call request of the remote subscriber meets a condition of triggering forwarding are determined, to realize the call forwarding in different scenes. Compared with the existing techniques, embodiments of the present disclosure may predetermine a target forwarding subscriber and a condition of triggering forwarding more flexibly, and improve flexibility of call forwarding.

In an embodiment of the present disclosure, a mobile terminal including the above call forwarding device is provided.

Those skilled in the art can understand that all of or a portion of the processes in the method provided in the above embodiments can be implemented by related hardware with instruction of computer program. The computer program may be stored in a readable storage medium, such as a magnetic disk, an optical disk, a Read-Only Memory (ROM) or a Random Access Memory (RAM).

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A call forwarding method, comprising:
receiving an incoming call request from a remote subscriber;
determining whether the remote subscriber is a contact in an address book for whom a target forwarding subscriber has been predetermined and whether the incoming call request of the remote subscriber meets a condition of triggering forwarding; and
if the remote subscriber is the contact in the address book for whom the target forwarding subscriber has been predetermined, and the incoming call request of the remote subscriber meets the condition of triggering forwarding, forwarding the incoming call request of the remote subscriber to the target forwarding subscriber.

2. The method according to claim 1, wherein determining whether the incoming call request of the remote subscriber meets a condition of triggering forwarding comprises:
determining whether there is no response to the incoming call request of the remote subscriber within a predetermined time period; and
if the remote subscriber is the contact in the address book for whom the target forwarding subscriber has been predetermined, and the incoming call request of the remote subscriber meets the condition of triggering forwarding, forwarding the incoming call request of the remote subscriber to the target forwarding subscriber comprises: if the remote subscriber is the contact in the address book for whom the target forwarding subscriber has been predetermined, and there is no response to the incoming call request of the remote subscriber within the predetermined time period, forwarding the incoming call request of the remote subscriber to the target forwarding subscriber.

3. The method according to claim 1, wherein determining whether the incoming call request of the remote subscriber meets a condition of triggering forwarding comprises:
determining whether call forwarding indication for the incoming call request of the remote subscriber is received; and
if the remote subscriber is the contact in the address book for whom the target forwarding subscriber has been predetermined, and the incoming call request of the remote subscriber meets the condition of triggering forwarding, forwarding the incoming call request of the remote subscriber to the target forwarding subscriber comprises: if the remote subscriber is the contact in the address book for whom the target forwarding subscriber has been predetermined, and call forwarding indication for the incoming call request of the remote subscriber is received, forwarding the incoming call request of the remote subscriber to the target forwarding subscriber.

4. The method according to claim 1, wherein determining whether the incoming call request of the remote subscriber meets a condition of triggering forwarding comprises:
determining whether the incoming call request of the remote subscriber is received; and
if the remote subscriber is the contact in the address book for whom the target forwarding subscriber has been predetermined, and the incoming call request of the remote subscriber meets the condition of triggering forwarding, forwarding the incoming call request of the remote subscriber to the target forwarding subscriber comprises: if the remote subscriber is the contact in the address book for whom the target forwarding subscriber has been predetermined, forwarding the incoming call request of the remote subscriber to the target forwarding subscriber.

5. A call forwarding device, comprising:
a receiving circuitry configured to receive an incoming call request from a remote subscriber;
a determining circuitry configured to determine whether the remote subscriber is a contact in an address book for whom a target forwarding subscriber has been predetermined and whether the incoming call request of the remote subscriber meets a condition of triggering forwarding; and
a forwarding circuitry configured to: if the remote subscriber is the contact in the address book for whom the target forwarding subscriber has been predetermined, and the incoming call request of the remote subscriber meets the condition of triggering forwarding, forward the incoming call request of the remote subscriber to the target forwarding subscriber.

6. The device according to claim 5, wherein the determining circuitry is configured to determine whether there is no response to the incoming call request of the remote subscriber within a predetermined time period; and
the forwarding circuitry is configured to: if the remote subscriber is the contact in the address book for whom the target forwarding subscriber has been predetermined, and there is no response to the incoming call request of the remote subscriber within the predetermined time period, forward the incoming call request of the remote subscriber to the target forwarding subscriber.

7. The device according to claim 5, wherein the determining circuitry is configured to determine whether call forwarding indication for the incoming call request of the remote subscriber is received; and
the forwarding circuitry is configured to: if the remote subscriber is the contact in the address book for whom the target forwarding subscriber has been predetermined, and call forwarding indication for the incoming call request of the remote subscriber is received, forward the incoming call request of the remote subscriber to the target forwarding subscriber.

8. The device according to claim 5, wherein the determining circuitry is configured to determine whether the incoming call request of the remote subscriber is received; and
the forwarding circuitry is configured to: if the remote subscriber is the contact in the address book for whom the target forwarding subscriber has been predetermined, forward the incoming call request of the remote subscriber to the target forwarding subscriber.

9. A mobile terminal comprising a call forwarding device, wherein the call forwarding device comprises:
a receiving circuitry configured to receive an incoming call request from a remote subscriber;
a determining circuitry configured to determine whether the remote subscriber is a contact in an address book for whom a target forwarding subscriber has been predetermined and whether the incoming call request of the remote subscriber meets a condition of triggering forwarding; and
a forwarding circuitry configured to: if the remote subscriber is the contact in the address book for whom the target forwarding subscriber has been predetermined, and the incoming call request of the remote subscriber meets the condition of triggering forwarding, forward the incoming call request of the remote subscriber to the target forwarding subscriber.

10. The mobile terminal according to claim 9, wherein the determining circuitry is configured to determine whether there is no response to the incoming call request of the remote subscriber within a predetermined time period; and
the forwarding circuitry is configured to: if the remote subscriber is the contact in the address book for whom the target forwarding subscriber has been predetermined, and there is no response to the incoming call request of the remote subscriber within the predetermined time period, forward the incoming call request of the remote subscriber to the target forwarding subscriber.

11. The mobile terminal according to claim 9, wherein the determining circuitry is configured to determine whether call forwarding indication for the incoming call request of the remote subscriber is received; and
the forwarding circuitry is configured to: if the remote subscriber is the contact in the address book for whom the target forwarding subscriber has been predetermined, and call forwarding indication for the incoming call request of the remote subscriber is received, forward the incoming call request of the remote subscriber to the target forwarding subscriber.

12. The mobile terminal according to claim 9, wherein the determining circuitry is configured to determine whether the incoming call request of the remote subscriber is received; and
the forwarding circuitry is configured to: if the remote subscriber is the contact in the address book for whom the target forwarding subscriber has been predetermined, forward the incoming call request of the remote subscriber to the target forwarding subscriber.
